(19) United States
(12) Patent Application Publication
(10) Pub. No.: US 2018/0270378 A1
(43) Pub. Date: Sep. 20, 2018

(54) IMAGE PROCESSING APPARATUS, IMAGE PROCESSING METHOD AND NON-TRANSITORY RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Masaki Ichikawa, Mishima Shizuoka (JP)

(21) Appl. No.: 15/460,512

(22) Filed: Mar. 16, 2017

(51) Int. Cl. H04N 1/00; H04N 1/028

(52) U.S. Cl. CPC H04N 1/00785; H04N 1/00034; H04N 2201/0094; H04N 1/02815; H04N 1/00411; H04N 1/00068

(57) ABSTRACT

In accordance with an embodiment, an image processing apparatus comprises a sensor and a controller. The sensor detects a laser light reflected from a polygon mirror having a plurality of reflection surfaces. The controller determines whether to execute a position alignment control based on a detected detection interval of the laser light to execute the position alignment control in response to a result of the determination.

### FIELD

Embodiments described herein relate generally to an image processing apparatus, an image processing method, and a non-transitory recording medium.

### BACKGROUND

Conventionally, in an image processing apparatus, a technology for measuring a detection interval between signals detected by a BD (Beam Detect) sensor to correct deviation in a horizontal scanning direction is proposed. A technology for detecting temperature change of a photoconductive drum to carry out a position alignment control is proposed.

However, in the above technology, high-quality image cannot be provided because the position alignment control cannot be executed due to color deviations.

### BRIEF DESCRIPTION OF THE DRAWINGS

FIG. 1 is an external view illustrating an example of the overall constitution of an image processing apparatus 100 according to an embodiment;

FIG. 2 is a block diagram illustrating functional components of the image processing apparatus 100;

FIG. 3 is a diagram illustrating functional components of a printer 130 and periphery of the printer 130;

FIG. 4 is a flowchart illustrating a flow of a position alignment necessity determination processing;

FIG. 5 is a timing chart illustrating an operation timing of a counter;

FIG. 6 is a diagram illustrating an example of a count value stored in a memory 330; and

FIG. 7 is a flowchart illustrating a flow of a processing by a printer controller 134.

### DETAILED DESCRIPTION

In accordance with an embodiment, an image processing apparatus comprises a sensor and a controller. The sensor detects a laser light reflected from a polygon mirror having a plurality of reflection surfaces. The controller determines whether to execute a position alignment control based on a detected detection interval of the laser light to execute the position alignment control in response to a result of the determination.

Hereinafter, an embodiment of an image processing apparatus, an image processing method and a non-transitory recording medium is described with reference to the accompanying drawings.

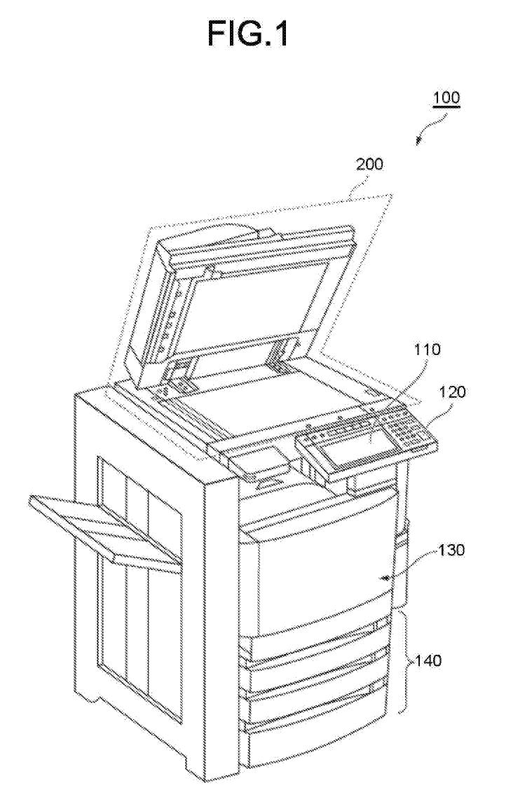

FIG. 1 is an external view illustrating an example of the overall constitution of an image processing apparatus 100 according to the embodiment.

The image processing apparatus 100 of the embodiment is a MFP (Multi Function Peripheral) capable of forming a toner image on a sheet. The sheet is, for example, a paper and the like on which a document, characters or images are recorded. The sheet may be an optional object as long as the image processing apparatus 100 can form an image on the surface thereof. The image processing apparatus 100 reads an image displayed on the sheet to generate digital data to generate an image file.

The image processing apparatus 100 is provided with a display 110, a control panel 120, a printer section 130, a sheet housing section 140 and an image reading section 200. Further, the printer section 130 of the image processing apparatus 100 may be a device for fixing a toner image. In the present embodiment, a case in which the printer section 130 is the device for fixing a toner image is described as an example.

The display 110 is an image display device such as a liquid crystal display, an organic EL (Electro Luminescence) display and the like. The display 110 displays various information relating to the image processing apparatus 100. The display 110 outputs a signal in response to an operation executed by the user to a controller of the image processing apparatus 100. The display 110 receives an operation by the user.

The control panel 120 includes a plurality of buttons. The control panel 120 receives an operation by the user. The control panel 120 outputs a signal in response to the operation executed by the user to the controller of the image processing apparatus 100. Further, the display 110 and the control panel 120 may be integrally configured as a touch panel.

The printer section 130 executes an image forming processing. In the image forming processing, the printer section 130 forms an image on the sheet based on image information generated by the image reading section 200 or image information received via a communication path. The printer section carries out a position alignment necessity determination processing before the start of printing. Herein, before the start of the printing refers to a period of warming up or a period from a moment a printing start job is input to a moment an image forming processing is executed. The position alignment necessity determination processing refers to a processing of determining whether or not the position alignment control in a horizontal scanning direction and a vertical scanning direction is necessary.

The sheet housing section 140 houses the sheet used for the image formation in the printer section 130.

The image reading section 200 reads the image information serving as a reading object as the intensity of light. For example, the image reading section 200 reads the image information printed on the sheet which is a read object and is set in the image processing apparatus 100. The image reading section 200 records the read image information. The recorded image information may be sent to another information processing apparatus via a network. The recorded image information may be used to form an image on the sheet by the printer section 130.

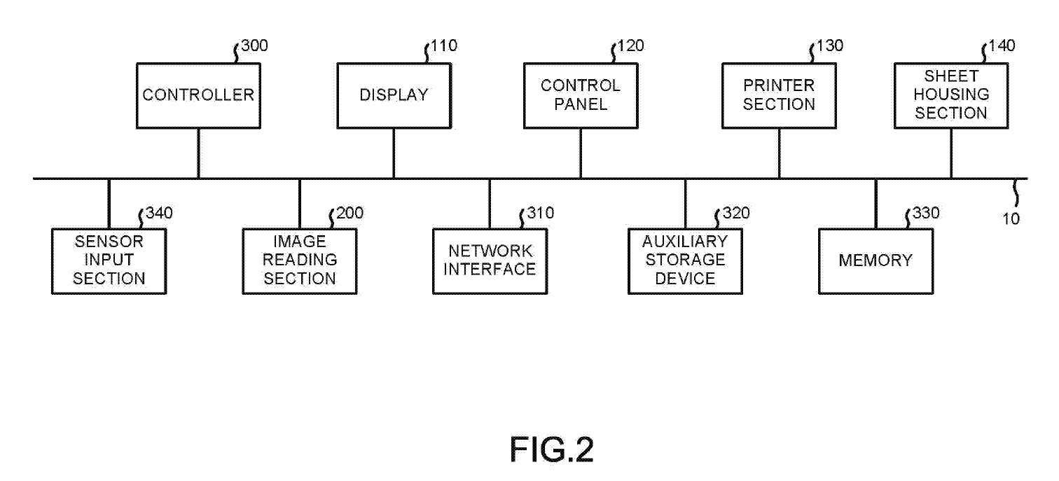

FIG. 2 is a block diagram illustrating functional components of the image processing apparatus 100.

The description of the display 110, the control panel 120, the printer section 130, the sheet housing section 140 and the image reading section 200 is the same as that described above, and thus, the description thereof is omitted. Hereinafter, a controller 300, a network interface 310, an auxiliary storage device 320, a memory 330 and a sensor input section 340 are described. Further, functional sections are connected with each other via a system bus 10 to be capable of communicating data.

The controller 300 controls operation of each functional section of the image processing apparatus 100. The controller 300 executes various processing through executing a program.

The network interface 310 executes transmission and reception of the data with other devices. The network interface 310 operates as an input interface to receive data sent from other devices. The network interface 310 operates as an output interface to send the data to other devices.

The auxiliary storage device 320 is, for example, a hard disk or an SSD (solid state drive), and stores various data. Various kinds of data include, for example, a list, digital data, a job and a job log. The digital data is digital data of the image information generated by the image reading section 200. Furthermore, the auxiliary storage device 320 may store a plurality of lists.

The memory 330 is, for example, a RAM (Random Access Memory). The memory 330 temporarily stores data used by each functional section of the image processing apparatus 100. Furthermore, the memory 330 may store the digital data generated by the image reading section 200. The memory 330 may temporarily store the job and job log.

The sensor input section 340 inputs a signal detected by a BD sensor. The sensor input section 340 outputs an input signal to the printer section 130.

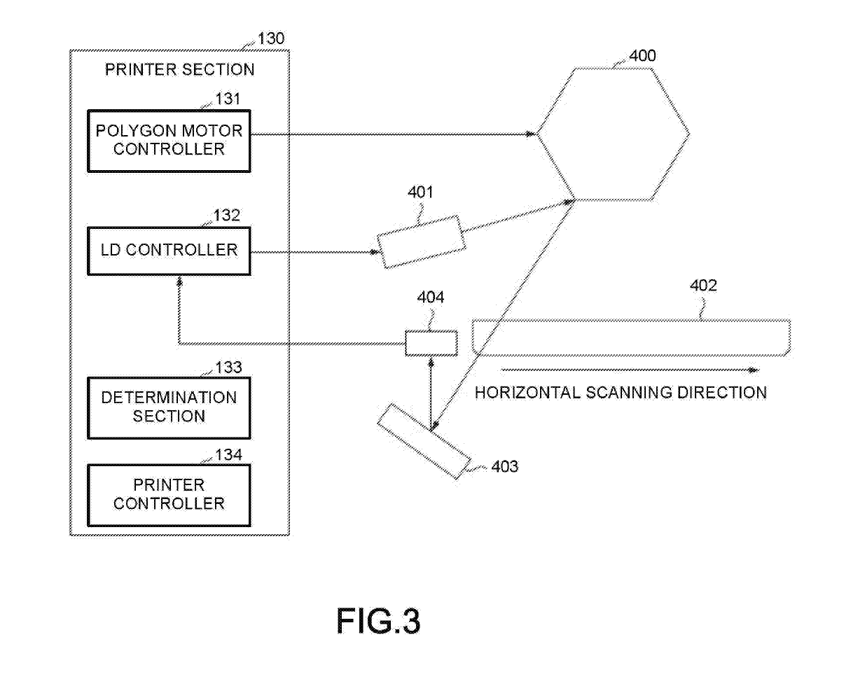

FIG. 3 is a diagram illustrating functional components of the printer 130 and periphery of the printer 130.

As shown in FIG. 3, the printer section 130 comprises a polygon motor controller 131, an LD controller 132, a determination section 133 and a printer controller 134. Further, a polygon mirror 400, an LD sensor 401, an fθ lens 402, a mirror 403 and a BD sensor 404 are arranged in the vicinity of the printer section 130.

The polygon motor controller 131 controls ON and OFF of the polygon motor for rotationally driving the polygon mirror 400.

The LD controller 132 controls the LD sensor 401. For example, the LD controller 132 controls an output timing of a laser light by the LD sensor 401. The LD controller 132 measures a detection interval between signals of the laser light detected by the BD sensor 404.

The determination section 133 determines whether or not the position alignment control is necessary based on the detection interval between the signals of the laser light measured by the LD controller 132.

The printer controller 134 carries out the position alignment control in a case in which the position alignment control is necessary. The printer controller 134 executes an image forming processing after the position alignment control is executed.

The polygon mirror 400 is a polygon mirror having a plurality of reflection surfaces. In the present embodiment, an example in which the polygon mirror 400 has six surfaces is described; however, the polygon mirror 400 may have optional surfaces as long as it has a plurality of surfaces, such as at least six surfaces or at least seven surfaces. The number of surfaces of the polygon mirror 400 may be determined by parameters such as a print speed and a resolution degree. The polygon mirror 400 counterclockwise rotates by the driving of the polygon motor.

The LD sensor 401 irradiates the laser light at a timing according to the control of the LD controller 132. The laser light irradiated from the LD sensor 401 is reflected as a reflection light which continuously changes angles by the reflection surfaces along with the rotation of the polygon mirror 400.

The fθ lens 402 enables the laser light reflected by the polygon mirror 400 to scan at an equal speed on an imaging plane.

The mirror 403 reflects the laser light reflected by the polygon mirror 400. The mirror 403 is arranged in such a manner that the laser light is reflected towards the BD sensor 404.

The BD sensor 404 detects the laser light reflected by the mirror 403. If the laser light is detected, the BD sensor 404 notifies the LD controller 132 via sensor input section 340 that the laser light is detected. The laser light detected by the BD sensor 404 is used as a scanning start reference signal of the horizontal scanning direction, and a writing start position in the horizontal scanning direction of each line is synchronized with reference to the laser light.

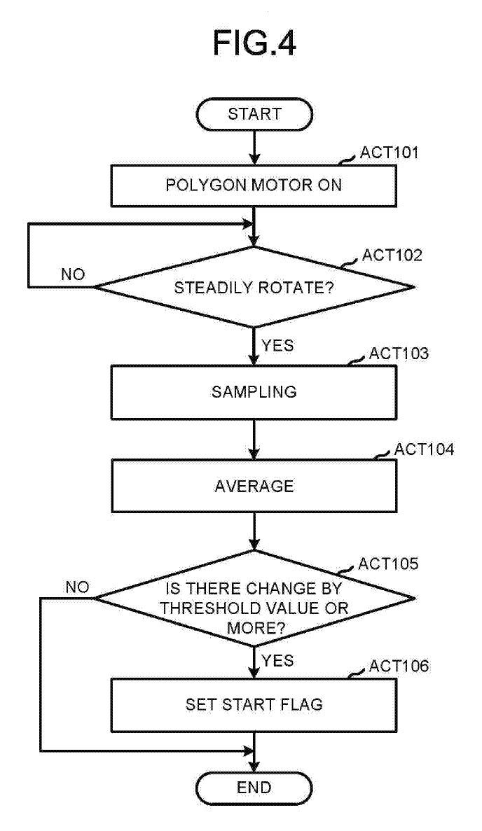

FIG. 4 is a flowchart illustrating a flow of the position alignment necessity determination processing. The processing in FIG. 4 is executed before the start of the printing.

The polygon motor controller 131 switches the polygon motor to an ON state at a timing before the start of the printing (ACT 101). By switching the polygon motor to the ON state, the polygon mirror 400 is rotationally driven. The polygon motor controller 131 determines whether or not the polygon motor steadily rotates (ACT 102). The determination on whether to steadily rotate may be executed by PLL (Phase Locked Loop) or based on time change.

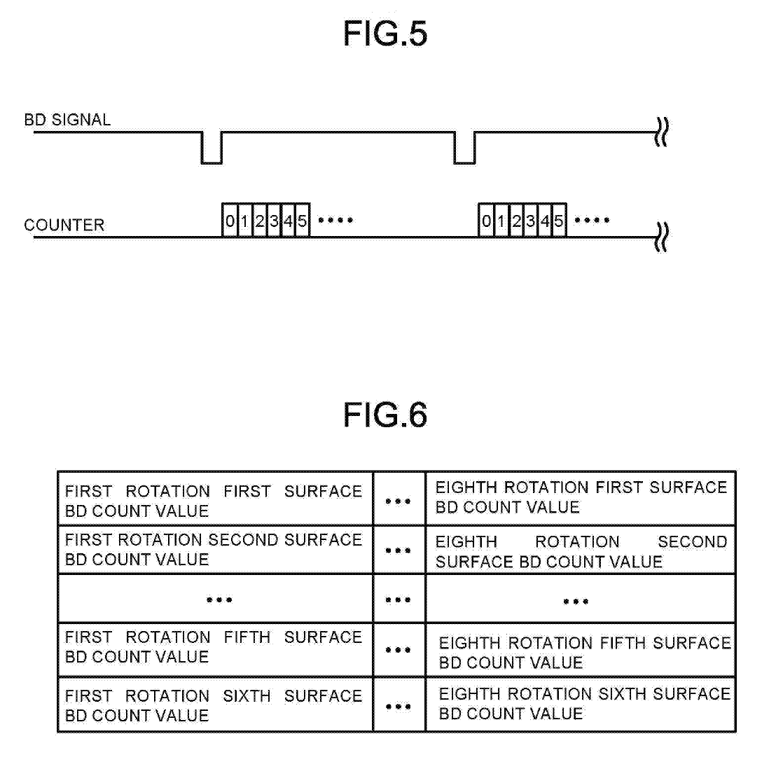

If the polygon motor steadily rotates (Yes in ACT 102), the LD controller 132 carries out sampling of the signal detected by the BD sensor 404 (ACT 103). In particular, the LD controller 132 counts count number from a time point at which the BD sensor 404 detects the signal to a time point at which a next signal is detected as shown in FIG. 5. In other words, the LD controller 132 counts time from a time point at which the BD sensor 404 detects the signal to a time point at which the next signal is detected. If the next signal is detected, the LD controller 132 counts the count number again while storing the count number as count value in the memory 330. In this way, the LD controller 132 measures the detection signal between the signals of the laser light detected by the BD sensor 404.

In the present embodiment, the LD controller 132 measures the count value of each surface of the polygon mirror 400 a predetermined number of times (number of rotations of the polygon mirror 400). In the present embodiment, as an example, the predetermined number of times is set to eight. The LD controller 132 measures count values for 6*8=48 times. The LD controller 132 stores each count value in the memory 330. The storage result of the count value is shown in FIG. 6.

If the sampling by the LD controller 132 is completed, the determination section 133 averages all the count values stored in the memory 330 (ACT 104). Specifically, the determination section 133 calculates an average value by calculating the average of all the count values. Thereafter, the determination section 133 compares the calculated average value with the average value stored in the memory 330 to determine whether or not there is a change by a threshold value or more (ACT 105). If there is a change by the threshold value or more (Yes in ACT 105), the determination section 133 sets a start flag indicating that the position alignment control is carried out in the memory 330 (ACT 106).

On the other hand, if there is no change by the threshold value or more (No in ACT 105), the image processing apparatus 100 terminates the processing.

In ACT 102, if the polygon motor does not steadily rotate (No in ACT 102), the image processing apparatus 100 stands by until the polygon motor steadily rotates.

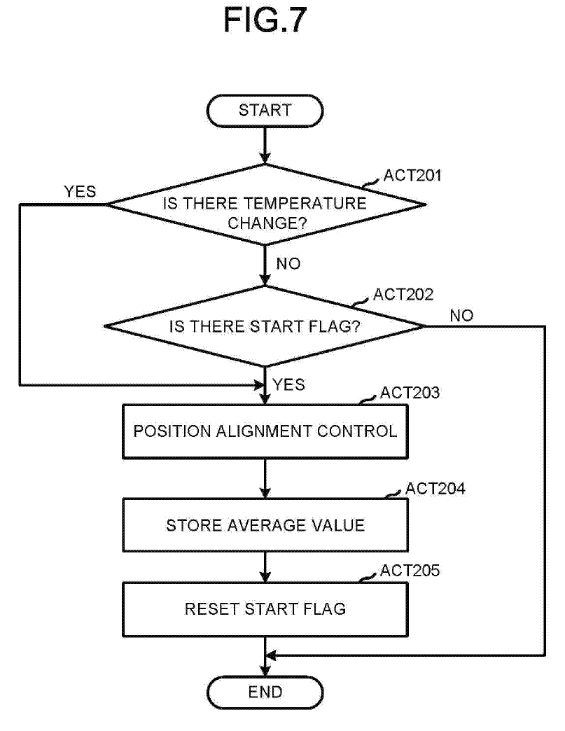

FIG. 7 is a flowchart illustrating a flow of a processing by the printer controller 134. The processing in FIG. 7 may be executed immediately after the processing in FIG. 6 is completed, or may be executed after a predetermined time elapses since the processing in FIG. 6 is completed.

The printer controller 134 determines whether or not the temperature of a photoconductive drum changes by a predetermined value or more (ACT 201). If the temperature of the photoconductive drum does not change by the predetermined value or more (No in ACT 201), the printer controller 134 refers to the memory 330 to determine whether or not the start flag is set (ACT 202). If the start flag is not set (No in ACT 202), the image processing apparatus 100 terminates the processing.

On the other hand, if the start flag is set (Yes in ACT 202), the printer controller 134 executes the position alignment control (ACT 203). In particular, first, the printer controller 134 forms a test pattern on a transfer belt (not shown). The test pattern formed on the transfer belt is read by a reflection-type optical sensor (not shown). Next, the printer controller 134 measures an amount of deviation in the horizontal scanning direction and the vertical scanning direction based on the read test pattern. The printer controller 134 executes the position alignment based on the measured amount of deviation. The printer controller 134 changes an image position of a horizontal scanning and a vertical scanning and an image magnification of the horizontal scanning based on the amount of deviation. The printer controller 134 outputs the amount of deviation to the LD controller 132 and the LD controller 132 changes an irradiation timing of the laser light based on the amount of deviation. The image processing apparatus 100 carries out the position alignment control as stated above. The LD controller 132 stores the average value calculated in the processing in ACT 104 in the memory 330 (ACT 204). Thereafter, the printer controller 134 resets the start flag set in the memory 330 (ACT 205). Specifically, the printer controller 134 resets the start flag by deleting the start flag set in the memory 330. Thereafter, the printer section 130 executes the image forming processing.

In accordance with the image processing apparatus 100 constituted as stated above, it is possible to supply a high-quality image. In particular, first, the image processing apparatus 100 detects the laser light output from the LD sensor 401 with the BD sensor 404. Next, the image processing apparatus 100 measures the detection interval of the detected laser light. The image processing apparatus 100 detects the deviation in the horizontal scanning direction based on the measured detection interval. In the present embodiment, if there is a deviation in the horizontal scanning direction, the image processing apparatus 100 estimates that a deviation in the vertical scanning direction also occurs and sets the start flag. Thus, the image processing apparatus 100 can execute the position alignment control. Therefore, it is possible to provide the high-quality image.

The image processing apparatus 100 measures a predetermined number of count values for each reflection surface of the polygon mirror 400. The image processing apparatus 100 calculates an average value by averaging the measured count values. The control of measured data can be enhanced.

The image processing apparatus 100 executes the position alignment control in a case in which the calculated average value changes by the threshold value or more as compared with the average value at the time of execution of the previous position alignment control. In a case in which the average value is deviated, there is a case in which a color deviation occurs. In this case, the image processing apparatus 100 executes the position alignment control. Thus, it is possible to provide the high-quality image.

Hereinafter, a modification of the image processing apparatus 100 is described.

The image processing apparatus 100 may not execute the processing in ACT 201 in the processing in FIG. 7. In other words, the image processing apparatus 100 may determine whether to execute the position alignment control depending on the presence and absence of the start flag.

In the present embodiment, the constitution in which all of the count value, the average value and the start flag are stored in the memory 330 is shown; however, the information may be stored in the auxiliary storage device 320.

According to at least one embodiment as described above, the image processing apparatus 100 has the sensor and the controller (the LD controller 132 and the printer controller 134). The sensor detects the laser light reflected from the polygon mirror having multiple reflection surfaces. The controller determines whether to carry out the position alignment control based on the detection interval of the detected laser light and executes the position alignment control according to the determination result. By having such a configuration, the image processing apparatus 100 can carry out the position alignment control, and it is possible to provide a high-quality image.

The functions of the image processing apparatus 100 according to the foregoing embodiment may be realized by a computer. In this case, programs for realizing the functions are recorded in a computer-readable recording medium and the programs recorded in the computer-readable recording medium may be read into a computer system to be executed. Further, it is assumed that the “computer system” described herein contains an OS or hardware such as peripheral devices. Further, the “computer-readable recording medium” refers to a portable medium such as a flexible disc, a magneto-optical disk, a ROM, a CD-ROM and the like or a storage device such as a hard disk built in the computer system. Furthermore, the “computer-readable recording medium” refers to a medium for dynamically holding the programs for a short time like a communication wire in a case in which the programs are sent via a communication line such as a network like the Internet or a telephone line, or may hold the programs for a certain time like a volatile memory in the computer system serving as a server and a client. The foregoing programs may realize a part of the above-mentioned functions, or may further realize the above-mentioned functions by the combination with programs already recorded in the computer.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. An image processing apparatus, comprising:
an image processing unit configured to form an image;
a laser light source configured to emit a laser light;
a polygon mirror configured to have a plurality of reflection surfaces, the polygon mirror reflects the laser light from the laser light source;
a sensor configured to detect the laser light reflected from the polygon mirror; and
a controller configured to measure a number of a count value for each reflection surface of the polygon mirror, and determine whether to execute a position alignment control of the image based on if the number of the count value is different from a reference value stored in advance.

2. The image processing apparatus according to claim 1, wherein
the controller is further configured to measure the number of the count value several times, calculate an average value by averaging the count value, and carry out the position alignment control in a case in which the average value differs from a threshold value or more compared with the reference value stored in advance.

3. The image processing apparatus according to claim 2, wherein
the controller is further configured to overwrite the reference value with the average value after executing the position alignment control.

4. The image processing apparatus according to claim 3, further comprising:
a determination section configured to store a flag indicating that the position alignment control is executed in a storage device in a case in which the average value changes by the threshold value or more compared with the reference value stored in advance.

5. The image processing apparatus according to claim 4, wherein
the controller is further configured to execute the position alignment control in a case in which the flag is stored in the storage device.

6. The image processing apparatus according to claim 1, wherein
the controller is further configured to execute the position alignment control in a case in which the temperature of a photoconductor changes by a predetermined value or more.

7. The image processing apparatus according to claim 1, wherein
the controller is further configured to output a predetermined pattern to a transfer belt, measure an amount of deviation in a horizontal scanning direction and a vertical scanning direction obtained from the predetermined pattern, and execute the position alignment based on the amount of deviation.

8. The image processing apparatus according to claim 7, wherein
the controller is further configured to execute the position alignment control by at least changing a radiation timing of the sensor, an image position of a horizontal scanning and a vertical scanning, and an image magnification of the horizontal scanning based on the amount of deviation.

9. The image processing apparatus according to claim 1, wherein
the polygon mirror has at least six reflection surfaces.

10. The image processing apparatus according to claim 1, wherein
the polygon mirror has at least seven reflection surfaces.

11. An image processing method, comprising:
measuring, by a device comprising a processor, a number of a count value for each reflection surface of a polygon mirror, wherein the polygon mirror comprises a plurality of reflection surfaces, and wherein the polygon mirror reflects laser light emitted from a laser light source to a sensor; and
in response to determining that the number of the count value differs from a reference value stored in advance, determining, by the device, whether to execute a position alignment control.

12. The image processing method according to claim 11, further comprising:
measuring, by the device, the number of the count value several times;
calculating, by the device, an average value by averaging the count value; and
carrying, by the device, out the position alignment control in a case in which the average value differs from a threshold value or more compared with the reference value stored in advance.

13. The image processing method according to claim 12, further comprising:
overwriting, by the device, the reference value with the average value after executing the position alignment control.

14. The image processing method according to claim 13, further comprising:
storing, by the device, a flag indicating that the position alignment control is executed in a storage device in a case in which the average value changes by the threshold value or more compared with the reference value stored in advance.

15. The image processing method according to claim 14, further comprising:
executing, by the device, the position alignment control in a case in which the flag is stored in the storage device.

16. The image processing method according to claim 11, further comprising:
executing, by the device, the position alignment control in a case in which the temperature of a photoconductor changes by a predetermined value or more.

17. The image processing method according to claim 11, further comprising:
outputting, by the device, a predetermined pattern to a transfer belt;
measuring, by the device, an amount of deviation in a horizontal scanning direction and a vertical scanning direction obtained from the predetermined pattern; and
executing, by the device, the position alignment based on the amount of deviation.

18. The image processing method according to claim 17, further comprising:
changing, by the device, a radiation timing of the sensor, an image position of a horizontal scanning and a vertical scanning, and an image magnification of the horizontal scanning based on the amount of deviation.

19. A non-transitory recording medium for storing a computer program configured to execute instructions to perform operations, comprising:
measuring a number of a count value for each reflection surface of a polygon mirror, wherein the polygon mirror comprises a plurality of reflection surfaces, and wherein the polygon mirror reflects laser light emitted from a laser light source to a sensor; and
in response to determining that the number of the count value differs from a reference value stored in advance.

20. The non-transitory recording medium according to claim 19, the computer program further configured to execute:
measuring the predetermined number of the count value several times;
calculating an average value by averaging the count value; and
carrying out the position alignment control in a case in which the average value differs from a threshold value or more compared with the reference value stored in advance.
